(19) United States
(12) Patent Application Publication
(10) Pub. No.: US 2009/0024930 A1
(43) Pub. Date: Jan. 22, 2009

(54) APPARATUS AND METHOD FOR CHANGING WEB DESIGN

(76) Inventor: Taek-Hun Kim, Tokyo (JP)

Correspondence Address: KANG INTELLECTUAL PROPERTY LAW, LLC, 214 ELM STREET, SUITE 106, WASHINGTON, MO, 63090, US

(21) Appl. No.: 12/278,338

(22) PCT Filed: Mar. 7, 2007
(86) PCT No.: PCT/KR07/01138

§ 371 Date: Aug. 5, 2008

(30) Foreign Application Priority Data
Mar. 9, 2006 (KR) 10-2006-0022394

(51) Int. Cl. G06F 3/00

(52) U.S. Cl. 715/744

(57) ABSTRACT

A web design changing apparatus includes a web server for displaying a web screen on a user terminal when a user logs in a web member page through the user terminal, the web server displaying the web screen by activating a web menu screen according to a controlled menu position, a controlled menu color and a controlled menu shape if the position, the color and the shape of the menu are controlled by the user; and a database server having a user database, a user design database and a CSS (cascade style sheet) database, the database server being connected to the web server. The web server combines CSS information with HTML codes to thereby output them on the user terminal, and stores CSS information modified by the user terminal in the database server.

### CROSS-REFERENCE TO RELATED APPLICATIONS

This application is a U.S. National Phase Application claiming priority from International Application No. PCT/KR2007/001138, filed Mar. 7, 2007 which claims priority from Korean Patent Application No. 10-2006-0022394, filed Mar. 9, 2006.

### STATEMENT REGARDING FEDERALLY SPONSORED RESEARCH

Not Applicable.

### APPENDIX

Not Applicable.

### BACKGROUND OF THE INVENTION

1. Field of the Invention

The present invention relates to an apparatus and a method for changing web design; and, more particularly, to an apparatus and method for changing web design, in which, a user can make a desired web design by easily controlling all describable variables about a position, a color and a shape of a menu by using click or drag and drop of a mouse on an admin page.

2. Related Art

In general, design of a web site is not creative although many users access web pages, and further, most of the web pages have, a difficulty in displaying a web design according to an interesting matter, a favorite matter and a preferred matter.

Among the above described web pages, blog is well known. The blog is a coined word and the meaning thereof is combined with “a web” meaning an internet and “logs” meaning a logbook, so that the blog means an internet diary or an internet logbook.

The blog has been developed in order to solve problems of anonymity, unilaterality and reduction of contents posting rate of a conventional internet bulletin board. The blog represents a so-called “one user media” capable of having his own area at the network by using a simple text or graphic manner.

Accordingly, in an aspect that the blog contains information of the user, it is being requested that the blog have to fulfill the user.

So, the blog emphasized in design has been developed and the pattern of the blog has two types.

The first type of the blog is a template type, in which the user can make his own blog design by using the previously-made templates by means of clicking a mouse in several times. The second type of the blog is a user setting type, in which the user can make his own blog design by setting variable values or coding HTML codes directly.

Almost, many blogs have been developed by mixing the above described two types, so that the user can use the basic templates and set option values.

Almost, many blogs have been developed by mixing the above described two types, so that the user can use the basic templates and set option values.

Almost, many blogs have been developed by mixing the above described two types, so that the user can use the basic templates and set option values.

Further, because the language for marking up and constructing a hypertext using HTML codes is used in the conventional blog, it has a difficulty in determining font kind, font size and font color of a portion and there are many limitation in configuring layer of the web page or decorating documents in the desired design.

### SUMMARY OF THE INVENTION

It is, therefore, an object of the present invention to provide an apparatus and a method for changing a web design by selectively setting a design and a menu of a web site or a blog, thereby allowing a user to facilitate the diversity of the web site or the blog and make them in a desired design.

It is another object of the present invention to provide an apparatus and a method for changing a web design, in which the properties of the menu objects are saved as the cascade style sheet (CSS) formal, thereby making the fixed HTML format more freely and smoothly, and further, the size of the document is reduced and the operating performance of the web service is enhanced by separating the cascade style sheet.

In accordance with one aspect of the invention, there is provided a web design changing apparatus including: a web server for displaying a web screen on a user terminal when a user logs in a web member page through the user terminal, the web server displaying the web screen by activating a web menu screen according to a controlled menu position, a controlled menu color and a controlled menu shape if the position, the color and the shape of the menu are controlled by the user; and a database server containing a user database, a user design database and a CSS (cascade style sheet) database, the database server being connected to the web server, wherein the web server combines CSS information with HTML codes to thereby output them on the user terminal, and stores CSS information modified by the user terminal in the database server.

In accordance with another aspect of the invention, there is provided a method for changing a web design including the steps of: (a) getting a CSS (cascade style sheet) information representing a web design property from a database server; (b) combining the CSS information with HTML codes and outputting them on a web admin page; (c) changing the CSS information on the web admin page by the user's control; and (d) storing the changed CSS information in the database server.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The above and other objects and features of the present invention will become apparent from the following description of preferred embodiments given in conjunction with the accompanying drawings, in which:

FIG. 1 is a schematic diagram of a web design changing system in accordance with a preferred embodiment of the present invention;

FIG. 2 sets forth a schematic inner configuration of a web service providing system in accordance with the preferred embodiment of the present invention;

FIG. 3 presents a flowchart depicting a method for changing a web design in accordance with the preferred embodiment of the present invention;

FIG. 4 provides a schematic diagram of a position and a color of a web menu before and after being changed in accordance with the flowchart depicting a method for changing the web design; and

FIG. 5 illustrates a subroutine of FIG. 3 presenting a flowchart depicting a method for changing the web design in accordance with the preferred embodiment of the present invention is attached.

### DETAILED DESCRIPTION OF THE PREFERRED EMBODIMENTS

The following description of the preferred embodiment(s) is merely exemplary in nature and is in no way intended to limit the invention, its application, or uses.

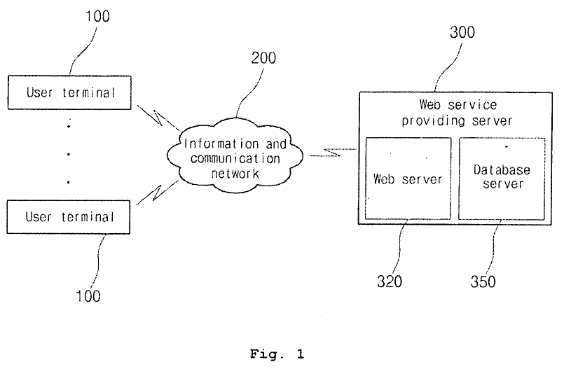

FIG. 1 is a schematic diagram of a web design changing system in accordance with a preferred embodiment of the present invention.

Referring to FIG. 1, the web design changing system is connected to a web service providing server 300 through an information and communication network 200, and further, the web design changing system includes a user terminal 100 for transmitting and receiving information data about variable contents provided from the web service providing server 300; and the web service providing server 300, wherein the web service providing server 300 has a web server 320 for managing web or blog content information and a database server 350 for storing therein data regarding to operation of the web service, the database server 350 being connected to the web server 320.

The user terminal 100 can be connected to the web service providing server 300 through the information and communication network 200 and can transmit and receive the information data about variable contents provided from the web service providing server 300. With the user terminal 100, the user can use the content information provided from the corresponding web site after connecting to the web service providing server 300.

The user terminal 100 can also control all describable variables about a position, a color and a shape of a menu by using click or drag and drop of a mouse on an admin page.

Moreover, the user terminal 100 has an internet browser, e.g., Netscape or Internet Explorer, for displaying the web content information as a HTML (Hyper Text Markup Language), a XML (eXtensible Markup Language) or a CSS (Cascade Style Sheet) format.

The information and communication network 200 is combined with exclusive network, LAN (Local Area Network), QAN (Quantum Area Network). VAN (Virtual Area Network), intranet, private switched telephone network, public switched telephone network and mixture thereof. Also, the information and communication network 200 is comprehensive concept for allowing the network objects shown in FIG. 1 to freely communicate with each other and includes a wire internet, a wireless internet and a mobile wireless communication network.

Since technical configurations related to the information and communication network 200 are disclosed to the ordinary person skilled in the art, detailed description thereof will be omitted.

The web service providing server 300 includes a web server 320 for managing the web or blog content information and a database server 350 for storing therein data regarding to operation of the web service, the database server 350 being connected to the web server 320.

With login of a web member page, the web server 320 displays the corresponding web or blog design to the user terminal 100. Further, if the user controls the position, the color and the shape of the menu implemented on the web screen, the web server 320 displays the controlled menu position, the controlled menu color and the controlled menu shape by activating web menu according to them.

The database server 350 includes a user database, a user design database, a cascade style sheet (CSS) database for use in operating the web service.

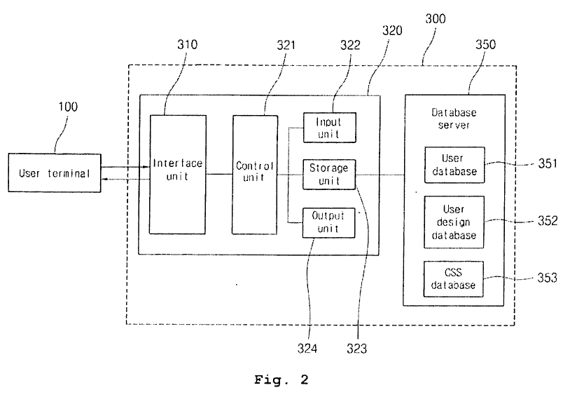

The database server 350 will be described in detail with reference to FIG. 2 later.

The web service providing server 300 can apply the design displayed on screen to the real design right after changing the web on the admin page by introducing a “WYSIWIG” concept in editing the menu.

Here, the “WYSIWIG” (What You See Is What You Got) concept means that text, picture, diagram or etc. of a document displayed on screen are printed out in the way they are. That is, the “WYSIWIG” has a function that the visual images displayed on the screen are printed out and it is used in the visually manipulating circumstance by the combination of the icons or in the printing circumstance by the world wide web (WWW) browser.

The web service providing server 300 stores therein an article list, a body content of the article, a classified folder (category) list, a recent visitor, a friend list, a profile, a calendar (daily or monthly) and the like. The web or blog is completed by the combination of the objects described above.

Moreover, since the web service providing server 300 is configured so as to manage all kinds of the menu properties as only one type of the CSS format, the frame layout of the web menu, the size or the color of the menu can be changed and some of the menu can be inserted or deleted.

FIG. 2 sets forth a schematic inner configuration of a web service providing system in accordance with the preferred embodiment of the present invention.

As shown in FIG. 2, the web service providing server 300 includes the interface unit 310, the web server 320 and the database server 350.

The interface unit 310 receives the information data from the user terminal 100.

The web server 320 activates a web or a blog menu window according to a background image, an icon, a text body and a font selected by the user.

The web server 320 includes an input unit 322 for receiving a position changing value of the web from the user terminal 100; a storage unit 323 for storing therein the web or the blog content information according to user's requesting value inputted from the input unit 322; an output unit 324 for outputting the web or the blog content information stored in the storage unit 323; and a control unit 321 for controlling each unit.

The input unit 322 receives the data information inputted from the user terminal 100 through the interface unit 310.

The storage unit 323 stores therein the user's requesting value and the web or the blog content information according thereto.

The output unit 324 outputs the results of controlling the inner configuration of the web by the user.

The control unit 321 controls each unit, thereby making the desired web design.

The database server 350 includes a user database 351, a user design database 352 and a cascade style sheet (CSS) database 353.

The user database 351 stores therein icon information, e.g., a web or blog name of the user, a web site URL (Uniform Resource Locator), a proper number of the user terminal, profile information, comment information, a article, a friend list, visitor statistical information.

The user design database 352 stores therein the background (image, color, pattern, position), the icon (article list, classified folder (category) list, recent visitor, friend list, profile, calendar (daily or monthly)), the text body (body type, background color, font color, body line, body position) and the accessory information and the position thereof.

Further, the user design database 352 has a background image unit, an icon type unit, a text body type unit, a color processing unit and an interior processing unit.

The background image unit stores therein the background of the web page and images thereof according to a control signal inputted from the user terminal in the user-registered web or blog.

The icon type unit stores therein variable icon information that the user desires.

For example, the icon type unit stores therein the article list, the classified folder (category) list, the recent visitor, the friend list, the profile, the calendar (daily or monthly).

The text body unit stores therein a text type corresponding to the icon information.

That is, the text body unit has an iframe type and a frame type. In case of the iframe type, i.e., insert frame, the selected information is inserted in the proper position of the previously page by separating the entire page into frames or by using the layout without separating the page if difficulty in configuring the page. In case of the frame type, the selected information is inserted without dividing the frames.

The color processing unit stores therein the icon types described above and color information about the web.

The font processing unit stores therein the icon types and variable fonts required in displaying the text body.

The interior processing unit stores therein position information of the icon types.

The CSS database 353 as the cascade style sheet stores therein the data information as the CSS format in order to set the properties of the color, the size and the like, of the web or the blog.

The CSS database 353 stores therein the CSS information of the user and can allow the user to apply the web design to another web design, thereby exchanging web or blog designs with each other and providing the diverse web or blog designs to users.

Further, the CSS database 353 stores therein the user SKIN file (txt format) at the same time when the CSS information is stored in order to reduce the database connection load.

The generated and stored SKIN file represents the user's web or blog design as the mixture of the CSS information stored in the CSS database 353 and the HTML page information.

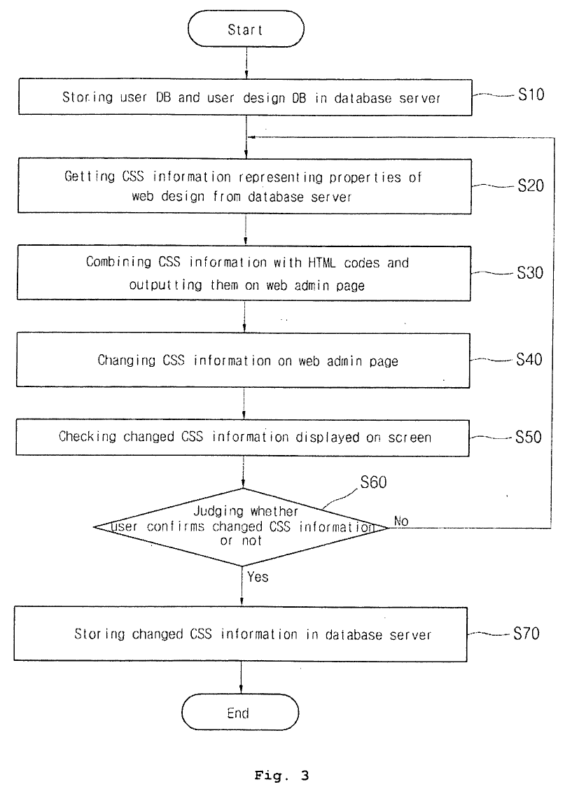

FIG. 3 presents a flowchart depicting a method for changing the web design in accordance with the preferred embodiment of the present invention.

As shown in FIG. 3, the control unit stores the user database and the user design database, which are configured in order to display the user's web or blog design, in the database server (step S10).

At step S10, the user stores the web or blog name, the profile information, the icon information, the comment information, the article, the friend list with connection to the web service providing server through the user terminal.

Next, the control unit of the web service providing server gets the cascade style sheet information representing the properties of the web or blog design from the database server (step S20).

At step S20, the user selects his own web or blog to be changed or modified through the user terminal, and gels the cascade style sheet information representing the properties of the selected web or blog design from the database server.

The cascade style sheet is a style sheet for making the fixed HTML formal more freely and smoothly. Under the HTML format, it is very troublesome in determining the font type, the font size and the font color of each portion. Accordingly, the size of the document can be reduced and the operating performance of the web service can be enhanced by separating the cascade style sheet.

The control unit combines the cascade style sheet information with the HTML codes, thereby outputting them on the web admin page (step S30).

At step S30, the data information is outputted on the user terminal by combining the CSS database, the user database, and the user design database stored in the database server according to the signal inputted from the user terminal.

The method for outputting the menu is shown with reference to the source code of Table 1 below.

The control unit executes a menu control process for changing the cascade style sheet information on the web admin page (step S40).

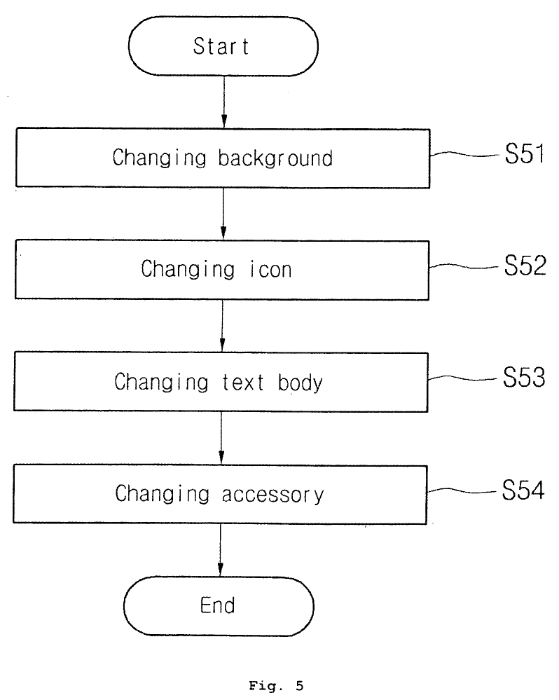

At step S40, the menu is controlled by the user's intent and the background, the icon type, the text body, and the position of the accessory are changed, which will be described in detail in FIG. 5.

The control unit performs a process for immediately checking the changed cascade style sheet information result on the screen right after being changed (step S50).

Next, the control unit executes a process for judging whether the user re-changes the cascade style sheet information or not (step S60).

At step S60, the control unit executes the step S20 in case of receiving the signal for re-changing the cascade style sheet and executes step S70 in case of confirming the changed cascade style sheet without re-changing it.

Next, the control unit stores the changed style sheet information in the database server (step S70).

At step S70, control signal is inputted from the user terminal through the screen outputted to the user terminal and the changed cascade style sheet information is stored in the database server. The background (image, color, pattern, position), the icon (article list, classified folder (category) list, recent visitor, friend list, profile, calendar (daily or monthly)), the text body (body type, background color, font color, body line, body position) and the accessory position information are stored in the database server as the CSS format.

The method for storing the above information in the database server is referred to Table 2 below.

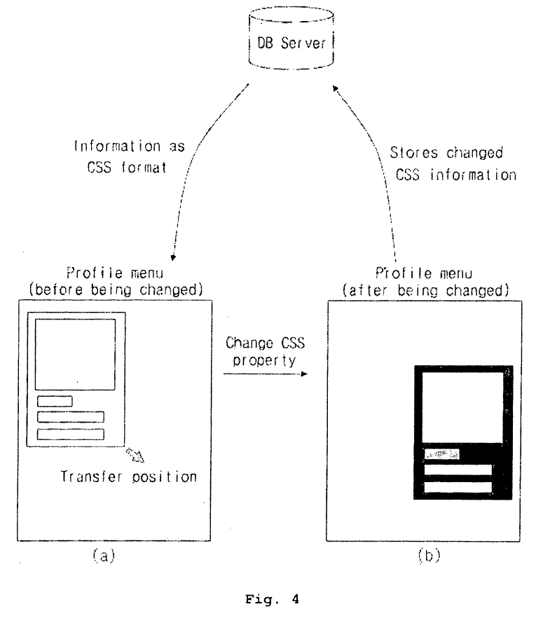

FIG. 4 provides a schematic diagram of the position and the color of the web menu before and after being changed in accordance with the flowchart depicting the method for changing the web design.

Referring to FIG. 4, if the user controls the user terminal by dragging and dropping the mouse, the profile menu window position previously existing on the screen (a) is changed to that on the screen (b) to thereby modify the design.

When the window position on the screen (a) is changed to that on the screen (b), the web service providing server changes the CSS information according to the information of the menu position and the menu color controlled by the user terminal. Thereafter, the web service providing server stores the changed CSS information in the database server, thereby outputting the result on the screen (b) to the user terminal screen.

FIG. 5 illustrates a subroutine of FIG. 3 presenting a flowchart depicting a method for changing the web design in accordance with the preferred embodiment of the present invention is attached.

As shown in FIG. 5, the control unit receives the signal for controlling the background changes from the user terminal (step S51).

At step S51, the background image upload, the change of the background color, the background pattern or the background position are changed by the data stored in the background image unit.

The control unit changes the icon type according to the changed background (step S52).

At step S52, the background color, the line style, the thickness, the font color, the icon shape and the icon position are changed by adding or deleting the menu.

At step S53, the control unit judges whether it is iframe type or frame type by the control signal inputted from the user terminal. In case of the iframe type, i.e. insert frame, the selected information is inserted in the proper position of the previously page by separating the entire page into frames or by using the layout without separating the page if difficulty in configuring the page. In case of the frame type, the selected information is inserted without dividing the frames.

That is, if the user selects the iframe type, the proper sized frame is inserted without breaking the basic frame configuration. Otherwise, the text body is inserted without dividing the basic frame configuration.

Next, the control unit changes the accessory information of the web or blog (step S54). Next, the control unit changes the accessory information of the web or blog (step S54).

At step S54, the user easily modifies the accessory information with reference to Table 3 by changing the CSS information with drag and drop.

By the above described method, the user can easily change the menu position, the menu shape, the menu font and the menu color of the user's own web or blog according to the user's desire.

In accordance with the present invention, the monotonous and the stationary characteristics of the conventional web service can be overcome, and the creative and different web service is realized, thereby enhancing the competitiveness power of the web service.

Further, in accordance with the present invention, the properties of the menu objects are saved as the cascade style sheet (CSS) format, thereby making the fixed HTML format more freely and smoothly, and further, the size of the document is reduced and the operating performance of the web service is enhanced by separating the cascade style sheet.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A web design changing apparatus comprising:
a web server 320 for displaying a web screen on a user terminal when a user logs in a web member page through the user terminal, the web server displaying the web screen by activating a web menu screen according to a controlled menu position, a controlled menu color and a controlled menu shape if the position, the color and the shape of the menu are controlled by the user; and
a database server 350 including a user database, a user design database and a CSS (cascade style sheet) database, the database server being connected to the web server,
wherein the web server combines CSS information with HTML codes to thereby output them on the user terminal 100, and stores CSS information modified by the user terminal in the database server 350.

2. The apparatus of claim 1, wherein the user controls all describable variables about the position, the color and the shape of the menu by using a click or drag and drop of a mouse on a web admin page.

3. The apparatus of claim 1, wherein the user database stores therein at least one of a web site name, a web site URL (Uniform Resource Locator), a proper number of the user terminal, profile information, comment information, a article, a friend list and visitor statistical information.

4. The apparatus of claim 1, wherein the user design database stores therein at least one of a background (image, color, pattern, position), an icon (article list, classified folder (category) list, recent visitor, friend list, profile, calendar (daily or monthly)), a text body (body type, background color, font color, body line, body position) and accessory information.

5. The apparatus of claim 1, wherein the web server 320 includes:
an input unit 322 for receiving a changed position value of the web from the user terminal;
a storage unit 323 for storing therein a user's requesting value inputted from the input unit and for storing therein web or blog content information related to the requesting value;
an output unit 324 for outputting the web or blog content information stored in the storage unit; and
a control unit 321 for controlling each unit and outputting the information to the user terminal, the control unit allowing the user to change the web design.

6. The apparatus of claim 1, wherein the cascade style sheet database stores therein the CSS information of the user and allows the user to apply the web design to another web design.

7. A method for changing a web design comprising the steps of:
(a) getting a CSS (cascade style sheet) information representing a web design property from a database server;
(b) combining the CSS information with HTML codes and outputting them on a web admin page;
(c) changing the CSS information on the web admin page by the user's control; and
(d) storing the changed CSS information in the database server.

8. The apparatus of claim 1 wherein the web design changing apparatus is applied for changing a personal blog design.

9. The method of claim 7, wherein the method is applied for changing a personal blog design.

10. The method of claim 7, the method further comprising the step of judging whether the user re-changes the changed CSS information by checking the changed CSS information on the screen of the user terminal after step (c).

11. The method of claim 7, wherein the user controls all describable variables about a position, a color and a shape of a menu by using click or drag and drop of a mouse on a web admin page.

12. The method of claim 7, the cascade style sheet database stores therein the CSS information of the user and allows the user to apply the web design to another web design.

13. The apparatus of claim 2 wherein the web design changing apparatus is applied for changing a personal blog design.

14. The apparatus of claim 3 wherein the web design changing apparatus is applied for changing a personal blog design.

15. The apparatus of claim 4 wherein the web design changing apparatus is applied for changing a personal blog design.

16. The apparatus of claim 5 wherein the web design changing apparatus is applied for changing a personal blog design.

17. The apparatus of claim 6 wherein the web design changing apparatus is applied for changing a personal blog design.
